(19) United States
(12) Patent Application Publication
(10) Pub. No.: US 2019/0350164 A1
(43) Pub. Date: Nov. 21, 2019

(54) AUTONOMOUS VOLUNTARY ROTARY MILKING-MACHINE AND METHOD

(71) Applicant: Brett Donald Green, Embro (CA)

(72) Inventor: Brett Donald Green, Embro (CA)

(21) Appl. No.: 15/980,601

(22) Filed: May 15, 2018

(51) Int. Cl. A01K 1/12; A01J 5/017

(52) U.S. Cl. CPC A01K 1/126; A01J 5/017

(57) ABSTRACT

A system for milking multiple bovines simultaneously is disclosed herein. The system includes a rotary-platform, a platform-drive, a plurality of enclosures, and a plurality of automatic milking-machines. The rotary-platform is round, having a platform-center and a platform-edge. The platform-drive is able to rotate the rotary platform about the platform-center. The plurality of enclosures is affixed to and rest upon the rotary-platform and are arrayed radially around the platform-center near the platform-edge. Each of the plurality of enclosures has an entry on the side of the enclosure nearest to the platform-edge. Each of the plurality of enclosures are structured to contain a cow and may be accessed by a cow voluntarily at any time when the system is incorporated into a milking barn. The plurality of milking-machines corresponds to the enclosures, such that one milking-machine is next to each enclosure to milk a cow residing in the enclosure.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of agriculture of existing art and more specifically relates to milking machines.

### RELATED ART

Innovations in the milking industry are often focused on increasing the productivity of milking cows in large scale milking farms. Machines such as the Rotolactor implemented in 1930, and the robotic milking machines used in more recent history, have drastically improved the output of modern milking farms. However, a primary inefficiency in modern milking farms that utilize these technologies is the need to corral and direct cows into the machines that perform the milking. Other inefficiencies may be found as well. In general, modern milking techniques not are entirely automated. In addition, forced milking in this manner may not always maximize milking output, as a cow may be ready for milking earlier than a scheduled milking time. A suitable solution is desired.

U.S. Pat. No. 8,286,584 to Krister Lindstrom relates to an arrangement and method for improving throughput in a rotary milking system. The described arrangement and method for improving throughput in a rotary milking system includes a method for improving the throughput of milking animals in a rotary milking system including a rotary platform, which milking animals enter and leave in a sequential order in order to be milked provides that a plurality of milking animals to be milked by the rotary milking system are identified; a measure indicative of the expected time required for performing at least one action on the rotary platform with respect to each of the milking animals is retrieved; and the milking animals are allowed to enter the rotary platform of the rotary milking system in an order, which is based on the measures indicative of the expected times required for performing the at least one action on the rotary platform with respect to the milking animals.

### SUMMARY OF THE INVENTION

In view of the foregoing disadvantages inherent in the known milking machine art, the present disclosure provides a novel autonomous voluntary rotary milking-machine and method. The general purpose of the present disclosure, which will be described subsequently in greater detail, is to provide an autonomous voluntary rotary milking-machine and method.

A system for milking multiple bovines simultaneously is disclosed herein. The system includes a rotary-platform, a platform-drive, a plurality of enclosures, and a plurality of automatic milking-machines. The rotary-platform is round, having a platform-center and a platform-edge. The platform-drive is able to rotate the rotary platform about the platform-center. The plurality of enclosures is affixed to and rests upon the rotary-platform and are arrayed radially around the platform-center near the platform-edge. Each of the plurality of enclosures has an entry on the side of the enclosure nearest to the platform-edge. Each of the plurality of enclosures are structured to contain a cow and may be accessed by a cow voluntarily at any time when the system is incorporated into a milking barn. The plurality of automatic milking-machines corresponds to the enclosures, such that one milking-machine is next to each enclosure for the purpose of milking a cow residing in the enclosure.

According to another embodiment, a method of voluntary rotary milking is also disclosed herein. The method of voluntary rotary milking includes providing the above-described invention, activating the platform-drive to rotate the rotary-platform about the platform-center, allowing one or more cows to enter the plurality of enclosures voluntarily, attaching the automatic milking-machines to the udders of the cows, milking the cows, and enabling the cows to exit the enclosures voluntarily.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an autonomous voluntary rotary milking-machine and method, constructed and operative according to the teachings of the present disclosure.

FIG. 1 is a perspective view of the system during an ‘in-use’ condition, according to an embodiment of the disclosure.

FIG. 2 is a perspective view of an alternative embodiment of the system of FIG. 1, according to an embodiment of the present disclosure.

FIG. 3 is a detail view of the plurality of automatic milking-machines of the system of FIG. 1, according to an embodiment of the present disclosure.

FIG. 4 is a detail view of the platform-drive of the system of FIG. 1, according to an embodiment of the present disclosure.

FIG. 5 is a detail view of the platform-drive of the system of FIG. 1, according to an embodiment of the present disclosure.

FIG. 6 is a flow diagram illustrating a method of use of voluntary rotary milking, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a milking machine and more particularly to an autonomous voluntary rotary milking-machine and method as used to improve the automation of milking several cows simultaneously.

Generally, the autonomous voluntary rotary milking-machine is an automated milking system which enables an efficient milking process by eliminating human labor. Primarily, this is done by combining a rotary milking platform with multiple robotic milking machines while also structuring the system to enable voluntary milking of cows. In this system cows do not need to be manually corralled or directed, as the are simply allowed or incentivized to enter an automatic milking station when they are ready to be milked. The stations are constructed in such a way that cows may enter and leave the station at will. When a cow enters a milking station, a robotic milking machines associated with the station may automatically sense the cow, attach to the teats of the cow, milk the cow, and accumulate milk. Not only is this system extremely efficient, but it may eliminate potential error causes by human labor and may decrease stress on the milking cows due to the voluntary nature of the system.

In a preferred embodiment, the stations include a modular enclosed stall unto which the cow many enter for milking. The stall may include three fixed sides, an enclosure gate, and optionally, a top barrier. Due to this structure, each cow must enter the stall forwardly, and must back out of the stall when ready to exit. Each stall may be serviced by a milking machine having a robotic arm to engage the teats of the cow. Preferably, the robotic arm operates by passing under the cow to perform operations. The rotary platform is preferably level with the floor of the barn so that cows do not have to be elevated onto the platform in any way. To accomplish this, the barn may include a recess in the floor to house the rotary platform. Furthermore, the platform preferably includes additional barriers between the stalls, so that cows may not walk freely over the top of the platform outside of an enclosure.

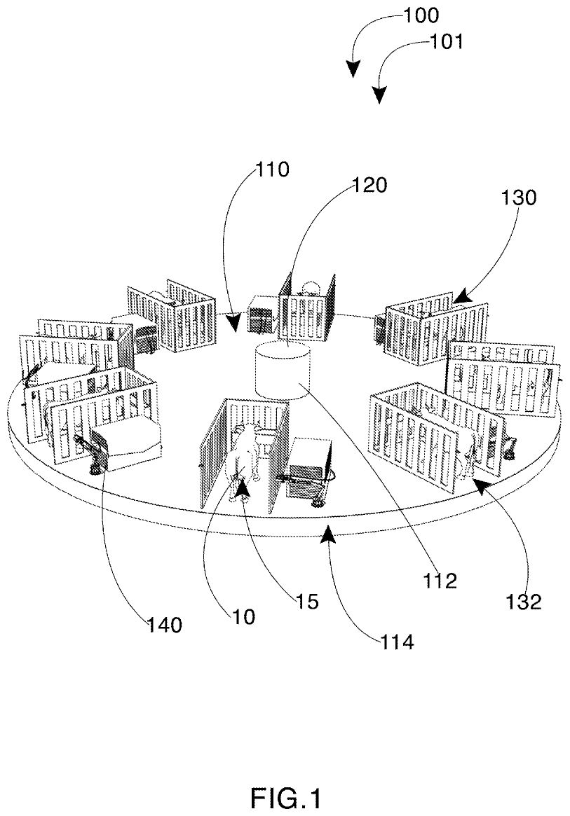

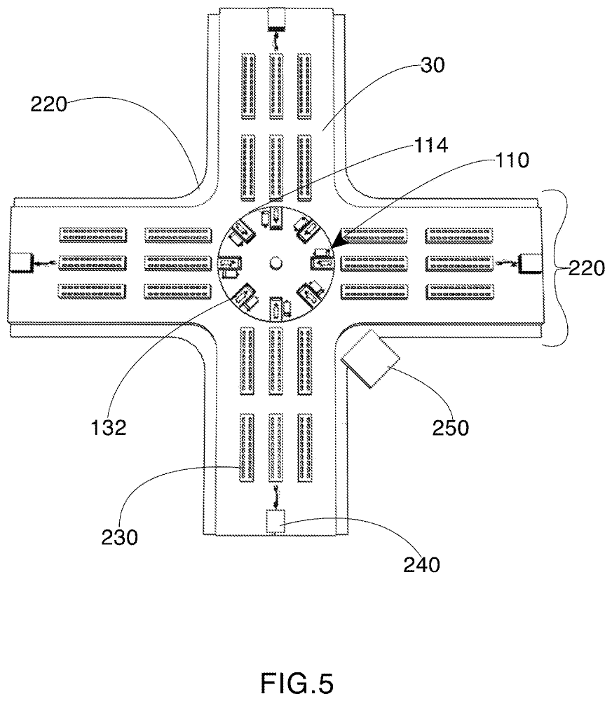

Referring now more specifically to the drawings by numerals of reference, there is shown in FIGS. 1-5, various views of a system 100.

FIG. 1 shows a system 100 according to an embodiment of the present disclosure. Here, system 100 may be beneficial to milk multiple bovines simultaneously. As illustrated, system 100 may include rotary-platform 110, platform-drive 120, plurality of enclosures 130, and plurality of automatic milking-machines 140. Rotary-platform 110 may have platform-center 112 and platform-edge 114. Platform-edge 114 may be round, bounding rotary-platform 110. Platform-drive 120 may be able to rotate rotary-platform 110 about platform-center 112. In some embodiments, platform-drive 120 may drive rotary-platform 110 clockwise. In other embodiments, platform-drive 120 may drive rotary-platform 110 counter-clockwise. Each of plurality of enclosures 130 may have entry 132 and may be affixed to rotary-platform 110, such that plurality of enclosures 130 are disposed radially about platform-center 112. Each of plurality of enclosures 130 may be structured and dimension to contain bovine 10 and may be position such that each of plurality of enclosures 130 are accessible by bovine 10 at any point during rotation cycle 101 as platform-drive 120 rotates rotary-platform 110. Plurality of automatic milking-machines 140 may correspond to plurality of enclosures 130 and may be able to attach to udder 15 of bovine 10 to automatically milk bovine 10.

Upon reading this specification, it should be appreciated that, under appropriate circumstances, considering such issues as user preferences, design preference, structural requirements, marketing preferences, cost, available materials, technological advances, etc., other structural arrangements such as, for example, the styles of enclosures used, the method of entry into the enclosures, the mechanism of the rotary drive, etc., may be sufficient.

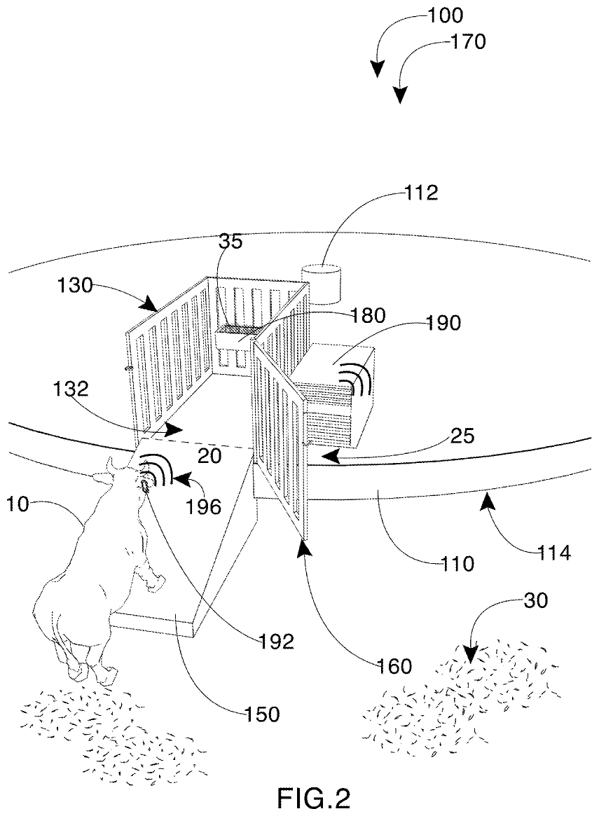

FIG. 2 shows the system of FIG. 1, according to an embodiment of the present disclosure. As above, the system 100 may include rotary platform 110 and plurality of enclosures 130. In one embodiment, system 100 may further include plurality of ramps 150. Plurality of ramps 150 may be placed proximate to platform-edge 114 of rotary-platform 110, such that bovine 10 can cross from plurality of ramps 150 to rotary-platform 110. Plurality of ramps 150 may circumscribe rotary-platform 110, and may be configured to provide bovine 10 with access to rotary-platform 110, as well as to each of plurality of enclosures 130 at any time. System 100 may further include plurality of gates 160. Plurality of gates 160 may correspond to plurality of enclosures 130, and may be hingedly attached to plurality of enclosures 130. One of plurality of gates 160 may be attached or integrated into each of plurality of enclosures 130. Plurality of gates 160 may be operable either manually or automatically to restrict access to entry 132 in closed position 20 and to enable access to entry 132 in open position 25 as shown. Preferably, plurality of gates 160 are operated automatically. Preferably, entry 132 is proximal to platform-edge 114 to enable convenient access to plurality of enclosures 130 for bovine 10. Entry 132 is configured such that bovine 10 may pass forwardly through entry 132 to access plurality of enclosures 130, and may back out through entry 132 to exit plurality of enclosures 130.

System may yet further include floor plan 170 for milking barn 30. Floor plan 170 may be configured to house bovine 10, and to effect efficient milking of bovine 10. Rotary-platform 110 may be placed within milking barn 30, such that bovine 10 is allowed unrestricted access to plurality of enclosures 130 and may enter and exit entry 132 of plurality of enclosures 130 voluntarily. Preferably, bovine 10 may be able to access rotary-platform 110 from three-hundred and sixty degrees around rotary-platform 110. However, various embodiments may allow anywhere between sixty and three-hundred and sixty degrees of access around rotary-platform 110. In one embodiment, floor plan 170 is a forced cow traffic plan, such that floor plan 170 requires bovine 10 to pass through entry 132 in order to access feed 35. In another embodiment, floor plan 170 is a free cow traffic plan, such that floor plan 170 allows bovine 10 to access feed 35 at any time without entering plurality of enclosures 130. System 100 may yet further include plurality of feed receptacles 180 corresponding to plurality of enclosures 130. Each of plurality of feed receptacles 180 may be placed distal to entry 132, such that bovine 10 might feed from plurality of feed receptacles 180 after passing through entry 132. Plurality of feed receptacles 180 may be proximal to platform-center 112. In some embodiments, system 100 may further include management system 190. Management system 190 may be able to identify bovine 10 and prevent milking if bovine 10 has been overmilked. Management system 190 may further include at least one radio frequency identification tag 192. Radio frequency identification tag 192 may be attached to bovine 10 and may be able to transmit identification signal 196 to management system 190.

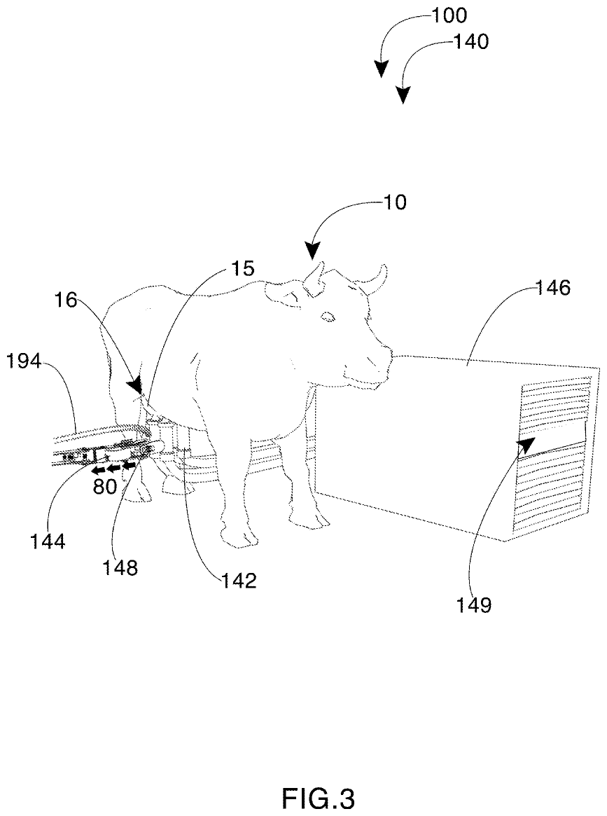

FIG. 3 is a detail view of the plurality of automatic milking-machines of the system of FIG. 1, according to an embodiment of the present disclosure. Each of plurality of automatic milking-machines 140 may further include teat-cup 142, robotic arm 144, milk-collector 146, teat-position sensor 148, and processor 149. Robotic-arm 144 may be able to pass under bovine 10 to access udder 15 as shown. Teat-cup 142 may be able to interface with udder 15 of bovine 10. Robotic arm 144 may be configured to effect automatic application and removal of teat-cup 142. Milk-collector 146 may be able to draw milk from teat-cup 142. Teat-position sensor 148 may be able to determine position 16 of udder 15 and produce position-signal 80. Processor 149 may be able to direct robotic arm 144 to position 16 of udder 15 based on position-signal 80. In one embodiment, teat-position sensor 148 is a laser sensor. Further, plurality of automatic milking-machines 140 may further include plurality of teat-cleaners 194.

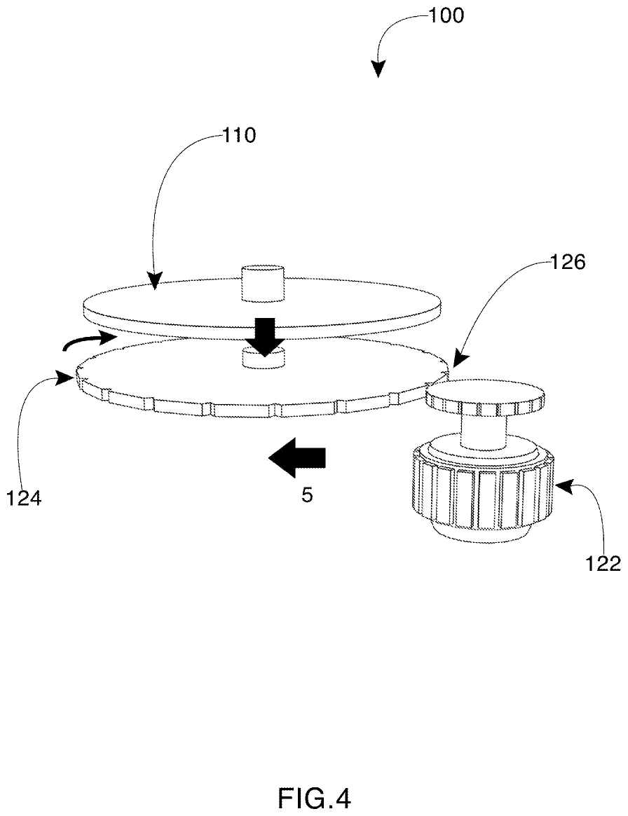

FIG. 4 is a detail view of the platform-drive of the system of FIG. 1, according to an embodiment of the present disclosure. As shown, platform-drive 120 (FIG. 1) may include electric motor 122. Electric motor may effect movement of rotary-platform 110. Platform-drive 120 may further include transmission 124 having gear reduction 126. Transmission 124 may be configured to increase effective torque 5 of platform-drive 120 (FIG. 1) exerted upon rotary-platform 110 by electric motor 122 as electric motor 122 drives transmission 124.

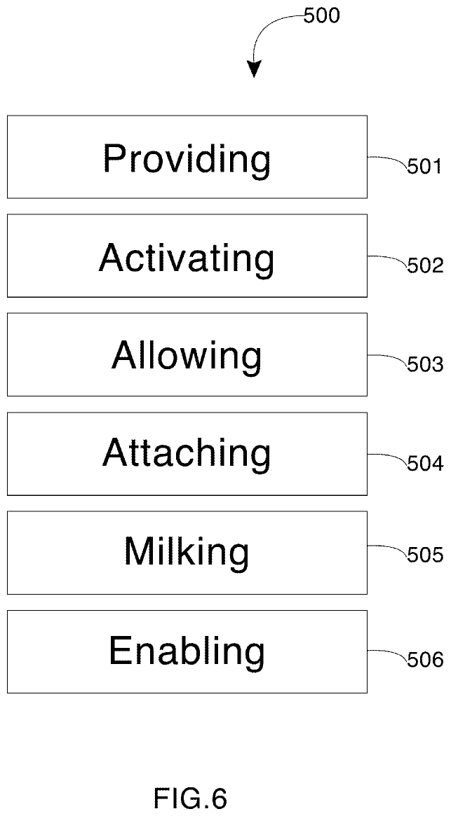

FIG. 6 is a flow diagram illustrating a method of voluntary rotary milking, according to an embodiment of the present disclosure. In particular, the method of voluntary rotary milking 500 may include one or more components or features of the system 100 as described above. As illustrated, the method of voluntary rotary milking 500 may include the steps of: step one 501, providing system for milking multiple bovines simultaneously, the system comprising a rotary-platform having a platform-center and a platform-edge, the platform-edge being circular, a platform-drive able to rotate the rotary-platform about the platform-center, a plurality of enclosures each having an entry, the plurality of enclosures being affixed to the rotary-platform, the plurality of enclosures being disposed radially about the platform-center, each of the plurality of enclosures being structured and dimension to contain a bovine, each of the plurality of enclosures being accessible by the bovine at any point during a rotation cycle, and a plurality of automatic milking-machines corresponding to the plurality of enclosures, the plurality of automatic milking-machines being able to attach to an udder of the bovine to automatically milk the steer; step two 502, activating the platform-drive to rotate the rotary-platform about the platform-center; step three 503, activating the platform-drive to rotate the rotary-platform about the platform-center; step four 504, allowing at least one bovine to enter the plurality of enclosures voluntarily; step five 505, attaching the plurality of automatic milking-machines to at least one teat of the at least one bovine; step six 506, milking the at least one bovine; and step seven 507, enabling at least one bovine to exit the plurality of enclosures voluntarily.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of voluntary rotary milking, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for milking multiple bovines simultaneously, the system comprising:
a rotary-platform having a platform-center and a platform-edge, the rotary platform being round;
a platform-drive able to rotate the rotary-platform about the platform-center;
a plurality of enclosures each having an entry, the plurality of enclosures being affixed to the rotary-platform, the plurality of enclosures being disposed radially about the platform-center, each of the plurality of enclosures being structured and dimension to contain a bovine, each of the plurality of enclosures being accessible by the bovine at any point during a rotation cycle; and
a plurality of automatic milking-machines corresponding to the plurality of enclosures, the plurality of automatic milking-machines being able to attach to an udder of the bovine to automatically milk the bovine.

2. The system of claim 1, further comprising a plurality of ramps proximate to the platform-edge of the rotary-platform, the plurality of ramps circumscribing the rotary-platform, the plurality of ramps being configured to provide the bovine with access to the rotary-platform.

3. The system of claim 1, further comprising a plurality of gates corresponding to the plurality of enclosures, the plurality of gates being hingedly attached to the plurality of enclosures, the plurality of gates being configured to restrict access to the entry in a closed position and to enable access to the entry in an open position.

4. The system of claim 1, wherein the entry is proximal to the platform-edge.

5. The system of claim 1, further comprising a floor plan for a milking barn configured to house the bovine, wherein the rotary-platform is placed within the milking barn, wherein the bovine is allowed unrestricted access to the plurality of enclosures, such that the bovine may enter and exit the entry of the plurality of enclosures voluntarily.

6. The system of claim 5, wherein the floor plan is a forced cow traffic plan, the floor plan requiring the bovine to pass through the entry in order to access feed.

7. The system of claim 5, wherein the floor plan is a free cow traffic plan, the floor plan allowing the bovine to access feed at any time.

8. The system of claim 1, wherein the platform-drive includes an electric motor.

9. The system of claim 1, wherein the platform-drive includes a transmission having a gear reduction configured to increase an effective torque of the platform-drive exerted upon the rotary-platform.

10. The system of claim 1, further comprising a plurality of feed receptacles corresponding to the plurality of enclosures, each of the plurality of feed receptacles being distal to the entry, such that the bovine might feed from the plurality of feed receptacles after passing through the entry.

11. The system of claim 10, wherein the plurality of feed receptacles is proximal to the platform-center.

12. The system of claim 1, wherein each of the plurality of automatic milking-machines further includes
a teat-cup able to interface with a bovine teat;
a robotic arm configured to effect automatic application and removal of the teat-cup;
a milk-collector able to draw milk from the teat-cup;
a teat-position sensor able to determine a position of the bovine teat and produce a position-signal; and
a processor able to direct the robotic arm to the position of the bovine teat based on the position-signal.

13. The system of claim 12, wherein the teat-position sensor is a laser sensor.

14. The system of claim 1, further comprising a management system able to identify the bovine and refuse milking if the bovine has been overmilked.

15. The system of claim 14, wherein the management system further includes at least one radio frequency identification tag attached to the bovine, the at least one radio frequency identification tag being configured to transmit an identification signal to the management system.

16. The system of claim 1, wherein the plurality of automatic milking-machines further includes a plurality of teat-cleaners.

17. An autonomous voluntary milking-machine for milking multiple bovines simultaneously, the autonomous voluntary milking-machine comprising:
a rotary-platform having a platform-center and a platform-edge, the rotary-platform being round;
a platform-drive able to rotate the rotary-platform about the platform-center;
a plurality of enclosures each having an entry, the plurality of enclosures being affixed to the rotary-platform, the plurality of enclosures being disposed radially about the platform-center, each of the plurality of enclosures being structured and dimension to contain a bovine, each of the plurality of enclosures being accessible by the bovine at any point during a rotation cycle; and
a plurality of automatic milking-machines corresponding to the plurality of enclosures, the plurality of automatic milking-machines being able to attach to an udder of the bovine to automatically milk the bovine;
wherein the entry is proximal to the platform-edge;
further comprising a floor plan for a milking barn configured to house the bovine, wherein the rotary-platform is placed within the milking barn, wherein the bovine is allowed unrestricted access to the plurality of enclosures, such that the bovine may enter and exit the entry of the plurality of enclosures voluntarily; and
wherein the rotary-platform is level with the floor of the milking barn;
wherein each of the plurality of automatic milking-machines further includes
a teat-cup able to interface with a bovine teat;
a robotic arm configured to effect automatic application and removal of the teat-cup;
a milk-collector able to draw milk from the teat-cup;
a teat-position sensor able to determine a position of the bovine teat and produce a position-signal; and
a processor able to direct the robotic arm to the position of the bovine teat based on the position-signal.

18. A method of voluntary rotary milking, the method comprising the steps of:
providing system for milking multiple bovines simultaneously, the system comprising a rotary-platform having a platform-center and a platform-edge, the platform-edge being circular, a platform-drive able to rotate the rotary-platform about the platform-center, a plurality of enclosures each having an entry, the plurality of enclosures being affixed to the rotary-platform, the plurality of enclosures being disposed radially about the platform-center, each of the plurality of enclosures being structured and dimension to contain a bovine, each of the plurality of enclosures being accessible by the bovine at any point during a rotation cycle, and a plurality of automatic milking-machines corresponding to the plurality of enclosures, the plurality of automatic milking-machines being able to attach to an udder of the bovine to automatically milk the steer;
activating the platform-drive to rotate the rotary-platform about the platform-center;
allowing at least one bovine to enter the plurality of enclosures voluntarily;
attaching the plurality of automatic milking-machines to at least one teat of the at least one bovine;
milking the at least one bovine; and
enabling at least one bovine to exit the plurality of enclosures voluntarily.
